(19) United States
(12) Patent Application Publication
(10) Pub. No.: US 2024/0001347 A1
(43) Pub. Date: Jan. 4, 2024

(54) IRON OXIDE PARTICLES AND METHOD FOR PRODUCING IRON OXIDE PARTICLES

(71) Applicant: DIC Corporation, Tokyo (JP)

(72) Inventors: Shaowei YANG, Qingdao (CN); Jianjun YUAN, Chiba (JP); Cheng LIU, Qingdao (CN); Meng LI, Qingdao (CN); Wei ZHAO, Qingdao (CN); Jian GUO, Qingdao (CN)

(21) Appl. No.: 18/254,107

(22) PCT Filed: Dec. 9, 2020
(86) PCT No.: PCT/CN2020/134786

§ 371 Date: May 23, 2023

(51) Int. Cl. B01J 23/881; B01J 35/00; B01J 35/10; B01J 37/00; B01J 37/08

(52) U.S. Cl. CPC B01J 23/881; B01J 35/006; B01J 35/1014; B01J 37/0072; B01J 37/08

(57) ABSTRACT

Iron oxide particles which have a polyhedral shape and which contain molybdenum. The crystallite size of the plane of the iron oxide particles is preferably 280 nm or more. Furthermore, a method for producing the iron oxide particles. The method includes calcining an iron compound in the presence of a molybdenum compound.

### TECHNICAL FIELD

The present invention relates to iron oxide particles and a method for producing the iron oxide particles.

### BACKGROUND ART

Iron oxide is widely used as material for pigments and it is known that hematite (α-Fe₂O₃) exhibits a reddish color, magnetite (Fe₃O₄) exhibits a blackish color, and maghemite (γ-Fe₂O₃) exhibits a dark brown color depending on a difference in crystal structure. Magnetite and hematite, which take advantage of magnetic characteristics, are used in materials for wave absorbers, noise suppression, high magnetic permeability materials, magnetic toner, magnetic recording, and the like in addition to applications for pigment materials.

For example, PTL 1 discloses that flake-shaped iron oxide microparticles which contain silicon and magnesium and which have a size of 0.01 μm to 100 μm and an aspect ratio of 3 to 200 are obtained by the hydrothermal reaction of an iron hydroxide-containing aqueous solution doped with silicon and magnesium.

PTL 2 discloses that a black pigment containing iron oxide microparticles having an average size of 50 nm to 120 nm and an Fe₃O₄ crystal structure is obtained in such a manner that, after red-brown iron oxide microparticles having a γ-Fe₂O₃ crystal structure are produced by a direct-current arc plasma method using an iron source material as a consumptive anodic electrode, the iron oxide microparticles are calcined in a reducing atmosphere.

PTL 3 discloses that iron oxide magnetic nanoparticles which are made of single-phase ε-Fe₂O₃ and which have an average size of 15 nm or less are obtained in such a manner that, after β-FeO(OH) nanoparticles are coated with silicon oxide, the silicon oxide-coated β-FeO(OH) nanoparticles are heat-treated in an oxidizing atmosphere.

### CITATION LIST

### Patent Literature

[PTL 1]
Japanese Unexamined Patent Application Publication No. 2008-254969
[PTL 2]
Japanese Unexamined Patent Application Publication No. 2002-104828
[PTL 3]
Japanese Unexamined Patent Application Publication No. 2014-224027

### SUMMARY OF INVENTION

### Technical Problem

However, in all methods for producing the iron oxide particles disclosed in PTLs 1 to 3, dispersion stability is poor and any particle shape cannot be stably controlled.

### Solution to Problem

Accordingly, it is an object of the present invention to provide iron oxide particles which exhibit low aggregation, which are excellent in dispersion stability, of which the shape can be stably controlled, and which have a polyhedral shape and a method for producing the iron oxide particles.

The present invention includes aspects below.

[1] Iron oxide particles having a polyhedral shape contain molybdenum.

[2] In the iron oxide particles specified in Item [1], the crystallite size of the plane of the iron oxide particles is 280 nm or more.

[3] In the iron oxide particles specified in Item [1] or [2], the crystallite size of the plane of the iron oxide particles is 260 nm or more.

[4] In the iron oxide particles specified in any one of Items [1] to [3], the median diameter D₅₀ of the iron oxide particles is 0.1 μm to 1,000 μm as determined by a laser diffraction/scattering method.

[5] In the iron oxide particles specified in any one of Items [1] to [4], the dispersity index S of the iron oxide particles is 2.0 or less as calculated from the 10% diameter D₁₀, median diameter D₅₀, and 90% diameter D₉₀ determined by the laser diffraction/scattering method using the following equation:

S=(D₉₀−D₁₀)/D₅₀ (1).

[6] In the iron oxide particles specified in any one of Items [1] to [5], the Fe₂O₃ content (F₁) of the iron oxide particles is 95.0% by mass to 99.99% by mass as determined by the XRF analysis of the iron oxide particles and the MoO₃ content (M₁) of the iron oxide particles is 0.01% by mass to 5.0% by mass as determined by the XRF analysis of the iron oxide particles.

[7] In the iron oxide particles specified in any one of Items [1] to [6], the molybdenum is unevenly distributed in a surface layer of each iron oxide particle.

[8] In the iron oxide particles specified in any one of Items [1] to [7], the Fe₂O₃ content (F₂) of the surface layer of each iron oxide particle is 88.0% by mass to 97.0% by mass as determined by the XPS surface analysis of the iron oxide particle and the MoO₃ content (M₂) of the surface layer of the iron oxide particle is 3.0% by mass to 12.0% by mass as determined by the XPS surface analysis of the iron oxide particle.

[9] In the iron oxide particles specified in any one of Items [1] to [8], the pH of the isoelectric point at which the potential is 0 is 2 to 5 as determined by zeta potential measurement.

[10] In the iron oxide particles specified in any one of Items [1] to [9], the specific surface area is 50 m²/g or less as determined by the BET method.

[11] A method for producing the iron oxide particles specified in any one of Items [1] to [10] includes calcining an iron compound in the presence of a molybdenum compound.

[12] In the method specified in Item [11], the iron compound is calcined in the presence of the molybdenum compound and an alkali metal compound.

[13] In the method specified in Item [12], the alkali metal compound is an alkali metal oxide, an alkali metal hydroxide, an alkali metal carbonate, or an alkali metal chloride.

[14] In the method specified in any one of Items [11] to [13], the molybdenum compound is molybdenum trioxide, lithium molybdate, potassium molybdate, or sodium molybdate.

[15] In the method specified in any one of Items [11] to [14], the maximum calcination temperature at which the iron compound is calcined is 800° C. to 1,600° C.

### Advantageous Effects of Invention

According to the present invention, iron oxide particles which exhibit low aggregation, which are excellent in dispersion stability, of which the shape can be stably controlled, and which have a polyhedral shape and a method for producing the iron oxide particles can be provided.

### BRIEF DESCRIPTION OF DRAWINGS

FIG. 1 is a SEM photograph of iron oxide particles obtained in Example 1.

FIG. 2 is a SEM photograph of iron oxide particles obtained in Example 2.

FIG. 3 is a SEM photograph of iron oxide particles obtained in Example 3.

FIG. 4 is a SEM photograph of iron oxide particles obtained in Example 4.

FIG. 5 is a SEM photograph of iron oxide particles obtained in Example 5.

FIG. 6 is a SEM photograph of iron oxide particles obtained in Example 6.

FIG. 7 is a SEM photograph of iron oxide particles obtained in Example 7.

FIG. 8 is a SEM photograph of iron oxide particles obtained in Example 8.

FIG. 9 is a SEM photograph of iron oxide particles obtained in Comparative Example 1.

FIG. 10 is a SEM photograph of iron oxide particles obtained in Comparative Example 2.

FIG. 11 is a graph showing X-ray diffraction (XRD) patterns of the iron oxide particles obtained in Examples 1 to 8 and Comparative Examples 1 and 2.

### DESCRIPTION OF EMBODIMENTS

[Iron Oxide Particles]

Iron oxide particles according to an embodiment of the present invention contain molybdenum and have a polyhedral shape.

The iron oxide particles contain molybdenum. In a production method described below, controlling the content and/or state of molybdenum enables the shape of the iron oxide particles to be stably controlled to the polyhedral shape and also enables physical properties and performance of the iron oxide particles and, for example, optical characteristics such as hue and transparency to be arbitrarily adjusted depending on applications used.

The crystallite size of the [110] plane of the iron oxide particles is preferably 280 nm or more, more preferably 300 nm or more, further more preferably 320 nm or more, and particularly preferably 340 nm or more. The crystallite size of the [110] plane of the iron oxide particles may be 800 nm or less, 750 nm or less, 700 nm or less, or 650 nm or less. The crystallite size of the [110] plane of the iron oxide particles may be 280 nm to 800 nm. The crystallite size of the [110] plane of the iron oxide particles is preferably 300 nm to 750 nm, more preferably 320 nm to 700 nm, and further more preferably 340 nm to 650 nm. Herein, the crystallite size of the [110] plane of the iron oxide particles is a value calculated from the full width at half maximum of a peak assigned to the [110] plane (that is, a peak appearing at a 2θ angle of about 35.6°) as measured by an X-ray diffraction method (XRD method) using the Scherrer equation.

The term “polyhedral shape” as used herein preferably refers to a shape with six or more flat surfaces, more preferably a shape with eight or more flat surfaces, and further more preferably a shape with ten to 30 flat surfaces. Among polyhedral shapes, a shape in which at least two surfaces forming a polyhedron are flat and in which the aspect ratio obtained by dividing the average particle size by the thickness is 2 or more is referred to as a “plate shape”.

Since the crystallite size of the [110] plane of the iron oxide particles is large, 280 nm or more, the crystallinity thereof can be maintained high, the average size thereof is likely to be controlled, and the particle size distribution is likely to be narrowly controlled.

The crystallite size of the [104] plane of the iron oxide particles is preferably 260 nm or more, more preferably 270 nm or more, and further more preferably 280 nm or more. The crystallite size of the [104] plane of the iron oxide particles may be 600 nm or less, 550 nm or less, or 500 nm or less. The crystallite size of the [104] plane of the iron oxide particles is preferably 260 nm to 600 nm, more preferably 270 nm to 550 nm, and further more preferably 280 nm to 500 nm. Herein, the crystallite size of the [104] plane of the iron oxide particles is a value calculated from the full width at half maximum of a peak assigned to the [104] plane (that is, a peak appearing at a 2θ angle of about 33.2°) as measured by an X-ray diffraction method (XRD method) using the Scherrer equation.

Since the crystallite size of the [110] plane of the iron oxide particles is 280 nm or more and the crystallite size of the [104] plane is large, 260 nm or more, the crystallinity thereof can be maintained high, the average size thereof is likely to be controlled, and the particle size distribution is likely to be narrowly controlled.

The median diameter D₅₀ of the iron oxide particles is preferably 0.1 μm to 1,000 μm, more preferably 0.5 μm to 600 μm, further more preferably 1.0 μm to 400 μm, and particularly preferably 2.0 μm to 200 μm as determined by a laser diffraction/scattering method.

The dispersity index S of the iron oxide particles is preferably 2.0 or less, more preferably 1.9 or less, and further more preferably 1.8 or less as calculated from the 10% diameter D₁₀, median diameter D₅₀, and 90% diameter D₉₀ determined by the laser diffraction/scattering method using the following equation:

S=(D₉₀−D₁₀)/D₅₀ (1).

The 10% diameter D₁₀, the median diameter D₅₀, and the 90% diameter D₉₀ are determined by the laser diffraction/scattering method. In particular, the 10% diameter D₁₀, the median diameter D₅₀, and the 90% diameter D₉₀ can be determined in such a manner that the particle size distribution is measured in a dry mode under conditions including a dispersive pressure of 3 bar and a suction pressure of 90 mbar using, for example, a laser diffraction particle size distribution measurement apparatus such as a laser diffraction particle size distribution analyzer, HELOS (H3355) & RODOS R3:0.5/0.9-175 μm, available from Japan Laser Corporation.

The iron oxide particles are preferably such that the Fe₂O₃ content (F₁) of the iron oxide particles is 95.0% by mass to 99.99% by mass as determined by the XRF analysis of the iron oxide particles and the MoO₃ content (M₁) of the iron oxide particles is 0.01% by mass to 5.0% by mass as determined by the XRF analysis of the iron oxide particles. The Fe₂O₃ content (F₁) and MoO₃ content (M₁) of the iron oxide particles can be measured by X-ray fluorescence (XRF) analysis using, for example, an X-ray fluorescence analyzer, Primus IV, available from Rigaku Corporation.

The iron oxide particles are preferably such that molybdenum is selectively rich in a surface layer of each iron oxide particle. The term “surface layer” as used herein refers to a portion within 10 nm from the surface of the iron oxide particle. This distance corresponds to the depth detected by XPS used for measurement in an example. The expression “surface enrichment” as used herein refers to a state that the mass of molybdenum or a molybdenum compound in the surface layer per unit area is larger than the mass of molybdenum or the molybdenum compound in a portion other than the surface layer per unit area.

The surface enrichment of molybdenum or the molybdenum compound in the surface layer allows the iron oxide particles to be more excellent in dispersion stability as compared to the presence of molybdenum or the molybdenum compound not only in the surface layer but also in a portion (an inner layer) other than the surface layer. The surface enrichment of molybdenum in the surface layer of each iron oxide particle can be confirmed by the fact that the MoO₃ content (M₂) of the surface layer of the iron oxide particle as determined by the XPS surface analysis of the iron oxide particle is higher than the MoO₃ content (M₁) of the iron oxide particle as determined by the XRF analysis of the iron oxide particle.

The iron oxide particles are preferably such that the Fe₂O₃ content (F₂) of the surface layer of each iron oxide particle is 88.0% by mass to 97.0% by mass as determined by the XPS surface analysis of the iron oxide particle and the MoO₃ content (M₂) of the surface layer of the iron oxide particle is 3.0% by mass to 12.0% by mass as determined by the XPS surface analysis of the iron oxide particle. The term “Fe₂O₃ content (F₂)” refers to a value that is determined in such a manner that the abundance (atomic percent) of each element is obtained by the XPS surface analysis of the iron oxide particle by X-ray photoelectron spectroscopy (XPS) and the content of Fe₂O₃ in the surface layer of the iron oxide particle is determined by converting the content of iron into the content of iron oxide. The term “MoO₃ content (M₂)” refers to a value that is determined in such a manner that the abundance (atomic percent) of each element is obtained by the XPS surface analysis of the iron oxide particle by X-ray photoelectron spectroscopy (XPS) and the content of MoO₃ in the surface layer of the iron oxide particle is determined by converting the content of molybdenum into the content of molybdenum trioxide.

The iron oxide particles are preferably such that the ratio of the MoO₃ content (M₂) of the surface layer of the iron oxide particle as determined by the XPS surface analysis of the iron oxide particle to the MoO₃ content (M₁) of the iron oxide particle as determined by the XRF analysis of the iron oxide particle, that is, the ratio of surface enrichment (M₂/M₁) is 2 to 80.

The iron oxide particles may further contain lithium, potassium, sodium, or silicon.

The iron oxide particles are such that the pH of the isoelectric point at which the potential is 0 (zero) as determined by zeta potential measurement is shifted to the acidic side as compared to usual iron oxide particles because molybdenum is unevenly distributed in the surface layer of each iron oxide particle. The pH of the isoelectric point at which the potential of the iron oxide particle is 0 (zero) is within the range of, for example, 2 to 5 and is preferably within the range of 2.3 to 4.5 and more preferably 2.5 to 4. When the pH of the isoelectric point is within the above range, the iron oxide particles have high electrostatic repulsion and the dispersion stability of the iron oxide particles blended with a dispersion medium can be increased.

The specific surface area of the iron oxide particles may be 50 m²/g or less, 30 m²/g or less, 10 m²/g or less, or 5 m²/g or less as determined by the BET method. The specific surface area of the iron oxide particles may be 0.1 m²/g to 50 m²/g, 0.1 m²/g to 30 m²/g, 0.1 m²/g to 10 m²/g, or 0.1 m²/g to 5 m²/g as determined by the BET method.

The average size of primary particles of the iron oxide particles may be 2 μm to 1,000 μm, 3 μm to 500 μm, 4 μm to 400 μm, or 5 μm to 200 μm.

The average size of primary particles of the iron oxide particles, which have the polyhedral shape, is the average of the sizes of randomly selected 50 of the primary particles as determined in such a manner that the iron oxide particles are photographed with a scanning electron microscope (SEM), the smallest unit particles (that is, the primary particles) forming agglomerates on a two-dimensional image are measured for the maximum diameter (the Feret diameter of the longest portion observed) and the minimum diameter (the short Feret diameter perpendicular to the Feret diameter of the longest portion), and the average thereof is defined as the primary particle size.

[Method for Producing Iron Oxide Particles]

A production method according to an embodiment of the present invention is a method for producing the iron oxide particles. The method for producing the iron oxide particles includes calcining an iron compound in the presence of the molybdenum compound.

In the method for producing the iron oxide particle, since the iron compound is calcined in the presence of the molybdenum compound, the shape of the iron oxide particles can be stably controlled, the crystallite size of the [110] plane of the iron oxide particles is allowed to be large, the iron oxide particles are allowed to have the polyhedral shape, and the iron oxide particles can exhibit low aggregation and excellent dispersion stability.

The method for producing the iron oxide particles preferably includes a step of mixing the iron compound and the molybdenum compound into a mixture (a mixing step) and a step of calcining the mixture (a calcination step).

[Mixing Step]

The mixing step is a step of mixing the iron compound and the molybdenum compound into the mixture. Contents of the mixture are described below.

[Iron Compound]

The iron compound is not particularly limited and may be a compound capable of being converted into iron oxide by calcination. The iron compound may be iron oxide, iron oxyhydroxide, or iron hydroxide and is not limited to these compounds. Examples of iron oxide include iron oxide (II) (FeO), which is so-called wustite; iron oxide (II, III) (Fe₃O₄), which is blackish; and iron oxide (III) (Fe₂O₃), which is reddish or red-brown. Examples of iron oxide (III) include α-Fe₂O₃, β-Fe₂O₃, γ-Fe₂O₃, and ε-Fe₂O₃. Examples of iron oxyhydroxide include α-iron oxyhydroxide, β-iron oxyhydroxide, γ-iron oxyhydroxide, and δ-iron oxyhydroxide. Examples of iron hydroxide include iron hydroxide (II) (Fe(OH)₂) and iron hydroxide (III) (Fe(OH)₃). Iron oxide is preferably iron oxide (III) (Fe₂O₃).

[Molybdenum Compound]

Examples of the molybdenum compound include molybdenum oxide and a molybdate.

Examples of the molybdenum oxide include molybdenum dioxide and molybdenum trioxide. The molybdenum oxide is preferably molybdenum trioxide.

The molybdate is not particularly limited and may be a salt of a molybdenum oxoanion such as MoO₄²⁻, Mo₂O₇²⁻, Mo₃O₁₀²⁻, Mo₄O₁₃²⁻, Mo₅O₁₆²⁻, Mo₆O₁₉²⁻, Mo₇O₂₄²⁻, or Mo₈O₂₆²⁻. The molybdate may be an alkali metal salt, alkaline-earth metal salt, or ammonia salt of the molybdenum oxoanion.

Examples of an alkali metal molybdate include potassium molybdates such as K₂MoO₄, K₂Mo₂O₇, K₂Mo₃O₁₀, K₂Mo₄O₁₃, K₂Mo₅O₁₆, K₂Mo₆O₁₉, K₆Mo₇O₂₄, and K₄Mo₈O₂₆; sodium molybdates such as Na₂MoO₄, Na₂Mo₂O₇, Na₂Mo₃O₁₀, Na₂Mo₄O₁₃, Na₂Mo₅O₁₆, Na₂Mo₆O₁₉, Na₆Mo₇O₂₄, and Na₄Mo₈O₂₆; and lithium molybdates such as Li₂MoO₄, Li₂Mo₂O₇, Li₂Mo₃O₁₀, Li₂Mo₄O₁₃, Li₂Mo₅O₁₆, Li₂Mo₆O₁₉, Li₆Mo₇O₂₄, and Li₄Mo₈O₂₆.

The molybdate is preferably an alkali metal salt of a molybdenum oxoanion and more preferably lithium molybdate, potassium molybdate, or sodium molybdate.

The alkali metal molybdate does not vaporize at calcination temperatures and can be readily recovered by washing after calcination. Therefore, the amount of the molybdenum compound released out of a calcination furnace is reduced and production costs can be significantly reduced.

The molybdenum compound may contain silicon. In this case, the molybdenum compound containing silicon functions as both a flux agent and a shape control agent.

In the method for producing the iron oxide particles, the molybdate may be a hydrate.

In the method for producing the iron oxide particles, the molybdenum compound is used as a flux agent. Hereinafter, the production method in which the molybdenum compound is used as a flux agent is simply referred to as the “flux method” in some cases. When, after the molybdenum compound reacts with the iron compound at high temperature during calcination to form iron molybdate, the iron molybdate decomposes into iron oxide and molybdenum oxide at higher temperature, the molybdenum compound is probably incorporated into the iron oxide particles. Molybdenum oxide sublimates and is removed outside a system and the molybdenum compound reacts with the iron compound in this course, so that the molybdenum compound is probably formed in the surface layer of each iron oxide particle. In particular, a mechanism of forming the molybdenum compound in the iron oxide particle is probably as follows: Mo—O—Fe is formed in the surface layer of the iron oxide particle by the reaction of molybdenum with iron and high-temperature calcination eliminates Mo and forms molybdenum oxide, a compound containing an Mo—O—Fe bond, or the like in the surface layer of the iron oxide particle.

Molybdenum oxide not incorporated into the iron oxide particle is recovered by sublimation and thereby can be reused. This enables the amount of molybdenum oxide adhering to the surface of the iron oxide particle to be reduced and also enables inherent properties of the iron oxide particle to be optimized. In the present invention, one capable of sublimating in a production method below is referred to as a flux agent and one incapable of sublimating is referred to as a shape control agent.

[Shape Control Agent]

The shape control agent can be used to form the iron oxide particles. The shape control agent plays an important role in growing a crystal of iron oxide by calcining the mixture in the presence of the molybdenum compound.

Examples of the shape control agent include an alkali metal compound and silicon oxide. The alkali metal compound is preferably an alkali metal oxide, an alkali metal hydroxide, an alkali metal carbonate, or an alkali metal chloride and more preferably the alkali metal carbonate. The shape control agent is preferably the alkali metal carbonate or silicon oxide. Examples of the alkali metal carbonate include potassium carbonate, lithium carbonate, and sodium carbonate. When the molybdate is an alkali metal salt, that is, when the molybdate is the alkali metal molybdate, the molybdenum compound and the alkali metal compound are regarded as being present under calcination conditions of a mixture of the iron compound and the alkali metal molybdate. The alkali metal molybdate functions as both a flux agent and a shape control agent.

In the method for producing the iron oxide particles, the amounts of the blended iron compound and molybdenum compound are not particularly limited. It is preferable that 35% by mass or more of the iron compound and 65% by mass or less of the molybdenum compound are mixed into a mixture, which may be calcined. It is more preferable that 40% by mass to 99% by mass of the iron compound and 0.5% by mass to 60% by mass of the molybdenum compound are mixed into a mixture, which may be calcined. It is further more preferable that 45% by mass to 95% by mass of the iron compound and 2% by mass to 55% by mass of the molybdenum compound are mixed into a mixture, which may be calcined.

Using the iron compound and the molybdenum compound within the above range allows the amount of the molybdenum compound contained in the obtained iron oxide particles to be appropriate, allows the polyhedral shape to be well formed, and enables the iron oxide particles to be produced such that the crystallite size of the [110] plane thereof is 280 nm or more.

[Calcination Step]

The calcination step is a step of calcining the above-mentioned mixture. The iron oxide particles are obtained by calcining the mixture. As described above, the production method is referred to as the flux method.

The flux method is categorized into a solution method. In particular, the flux method is a method for growing a crystal using the fact that a crystal-flux binary phase diagram shows a eutectic. A mechanism of the flux method is probably as described below. Heating a mixture of a solute and flux allows the solute and the flux to become liquid. On this occasion, the flux is a fusing agent, that is, a solute-flux binary phase diagram shows a eutectic; hence, the solute melts at a temperature lower than the melting point thereof to form a liquid phase. When the flux is vaporized in this state, the concentration of the flux decreases, that is, the effect of reducing the melting point of the solute decreases, so that the crystal growth of the solute occurs as the vaporization of the flux serves as driving force (a flux vaporization method). Incidentally, the solute and the flux can induce the crystal growth of the solute by cooling a liquid phase (an annealing method).

The flux method has merits such as the fact that crystal growth can be induced at a temperature much lower than a melting point, the fact that a crystal structure can be precisely controlled, and the fact that an idiomorphic polyhedral crystal can be formed.

In the production of the iron oxide particles by the flux method using the molybdenum compound as flux, a mechanism thereof is not necessarily clear but is probably as described below. Calcining the iron compound in the presence of the molybdenum compound first forms iron molybdate. On this occasion, the iron molybdate grows iron oxide crystals at a temperature lower than the melting point of iron oxide as is understood from the above description. Iron molybdate is decomposed by vaporizing, for example, flux and the iron oxide particles can be obtained by crystal growth. That is, the molybdenum compound functions as flux and the iron oxide particles are produced through an intermediate that is iron molybdate.

Furthermore, in the production of the iron oxide particles by the flux method using the shape control agent, a mechanism thereof is not necessarily clear. For example, when the shape control agent used is a potassium compound, a mechanism below is conceivable. First, the molybdenum compound reacts with the iron compound to form iron molybdate. Then, for example, iron molybdate decomposes into molybdenum oxide and iron oxide and the molybdenum compound containing molybdenum oxide obtained by decomposition reacts with the potassium compound to form potassium molybdate at the same time. Crystals of iron oxide grow in the presence of the molybdenum compound containing the potassium molybdate, whereby the iron oxide particles, which have the polyhedral shape, can be obtained.

The above flux method enables the iron oxide particles to be produced such that the iron oxide particles contain molybdenum and have the polyhedral shape and the crystallite size of the [110] plane thereof is 280 nm or more.

A method for calcining the iron compound is not particularly limited and may be a known common method. When the calcination temperature of the iron compound is higher than 650° C., the iron compound reacts with the molybdenum compound to form iron molybdate. Furthermore, when the calcination temperature of the iron compound is 800° C. or higher, iron molybdate decomposes and the iron oxide particles are formed by the action of the shape control agent. In the iron oxide particles, it is conceivable that when the iron molybdate decomposes into iron oxide and molybdenum oxide, the molybdenum compound is incorporated into the iron oxide particles.

In a case where the shape control agent used is, for example, the potassium compound, it is conceivable that when the calcination temperature of the iron compound is 1,000° C. or higher, a molybdenum compound (for example, molybdenum trioxide) obtained by the decomposition of iron molybdate reacts with the potassium compound to form potassium molybdate.

When the iron compound is calcined, the states of the iron compound and the molybdenum compound are not particularly limited and the iron compound and the molybdenum compound may be present in the same space such that the molybdenum compound can acts on the iron compound. In particular, a powder of the molybdenum compound and a powder of the iron compound may be simply mixed together or the iron compound and the molybdenum compound may be mechanically mixed together using a crusher or the like, may be mixed together using a mortar or the like, or may be mixed together in a dry or wet state.

Conditions for calcining the iron compound are not particularly limited and may be determined depending on the target average size of the iron oxide particles, the formation of the molybdenum compound in the iron oxide particles, the dispersibility, and/or the like. The maximum calcination temperature of the iron compound is preferably higher than or equal to 800° C., which is close to the decomposition temperature of iron molybdate, and more preferably higher than or equal to 900° C.

In general, controlling the shape of iron oxide obtained after calcination requires high-temperature calcination at a temperature higher than or equal to 1,500° C., which is close to the melting point of iron oxide. This is significantly problematic for industrial use from the viewpoint of a load on a calcination furnace and fuel costs.

The production method according to the present invention can be performed at a temperature exceeding 1,500° C. and can form the iron oxide particles, which have the polyhedral shape, at a temperature lower than or equal to 1,300° C., which is considerably lower than the melting point of iron oxide, such that the crystallite size of the [110] plane and the crystallite size of the [104] plane are large regardless of the shape of a precursor.

According to an embodiment of the present invention, the iron oxide particles can be efficiently formed at low cost under conditions including a maximum calcination temperature of 800° C. to 1,600° C. such that the iron oxide particles have the polyhedral shape and the crystallite size of the [110] plane and the crystallite size of the [104] plane are large. The maximum calcination temperature of the iron compound is preferably 850° C. to 1,500° C. and more preferably 900° C. to 1,400° C.

From the viewpoint of production efficiency, the heating rate of the iron compound may be 20° C./h to 600° C./h, 40° C./h to 500° C./h, or 80° C./h to 400° C./h.

The iron compound is preferably calcined in such a manner that the heating time taken to reach a predetermined maximum calcination temperature is within the range of 15 minutes to ten hours and the holding time at the maximum calcination temperature is within the range of five minutes to 30 hours. In order to efficiently form the iron oxide particles, the holding time at the maximum calcination temperature is more preferably about ten minutes to 15 hours. Selecting conditions including a maximum calcination temperature of 900° C. to 1,400° C. and a holding time of ten minutes to 15 hours at the maximum calcination temperature allows the iron oxide particles, which contain molybdenum and have the polyhedral shape, to be unlikely to aggregate and enables the iron oxide particles to be readily obtained.

A calcination atmosphere is not particularly limited and may be such that an effect of the present invention is obtained. The calcination atmosphere is preferably, for example, an oxygen-containing atmosphere such as an air or oxygen atmosphere or an inert atmosphere such as a nitrogen, argon, or carbon dioxide atmosphere and more preferably an air atmosphere in consideration of costs.

An apparatus for calcining the iron compound is not particularly limited and may be a so-called calcination furnace. The calcination furnace is preferably made of material not reactive with sublimated molybdenum oxide and is preferably highly hermetic such that molybdenum oxide is efficiently used.

This enables the amount of the molybdenum compound adhering to the surface of each iron oxide particle to be reduced and also enables inherent properties of the iron oxide particle to be optimized.

[Molybdenum-Removing Step]

The method for producing the iron oxide particles may further include a molybdenum-removing step of removing at least one portion of molybdenum after the calcination step as required.

Since molybdenum sublimates during calcination as described above, controlling the calcination temperature, the calcination time, or the like enables the content of molybdenum oxide in the surface layer of each iron oxide particle and also enables the content of molybdenum oxide in a portion (an inner layer) other than the surface layer of the iron oxide particle and the state of molybdenum oxide to be controlled.

Molybdenum can adhere to the surface of the iron oxide particle. The molybdenum can be removed by washing with water, an aqueous solution of ammonia, an aqueous solution of sodium hydroxide, or an acidic aqueous solution as a means other than the sublimation. The molybdenum need not be removed from the iron oxide particles and is preferably removed from at least the surface of each iron oxide particle because inherent properties of iron oxide can be sufficiently exhibited and failures due to the molybdenum present on the surface thereof do not occur when the iron oxide particles are used in such a manner that the iron oxide particles are dispersed in a dispersion medium based on various binders.

On this occasion, the content of molybdenum oxide can be controlled by appropriately varying the amount of water used, the aqueous solution of ammonia, the aqueous solution of sodium hydroxide, or the acidic aqueous solution; the concentration of the aqueous solution of ammonia, the aqueous solution of sodium hydroxide, or the acidic aqueous solution; a washed portion; the washing time; and the like.

[Crushing Step]

A calcined product obtained through the calcination step does not meet the range of the particle size that is appropriate for the present invention in some cases because the iron oxide particles aggregate. Therefore, the calcined product may be crushed as required so as to meet the range of the particle size that is appropriate for the present invention. A method for crushing the calcined product is not particularly limited and known crushing apparatus such as ball mills, jaw crushers, jet mills, disk mills, spectro mills, grinders, and mixer mills can be used to crush the calcined product.

[Classification Step]

The iron oxide particles are preferably classified for the purpose of adjusting the average size thereof, the purpose of enhancing the fluidity of powder, or the purpose of suppressing the increase in viscosity of a blend of the iron oxide particles and a binder for forming a matrix. The term “classification” refers to the operation of grouping particles depending on the size of the particles. Classification may be performed in either a wet or dry mode. From the viewpoint of production efficiency, dry classification is preferable. Examples of dry classification include classification by sieving and pneumatic classification in which classification is performed by the difference between the centrifugal force and the fluid drag. Pneumatic classification is preferable from the viewpoint of classification precision and can be performed using a classifier, such as an air classifier, a spiral air classifier, a forced vortex centrifugal classifier, or a quasi-free vortex centrifugal classifier, using the Coanda effect. The above-mentioned crushing step and classification step can be performed in a necessary stage. For example, the average size of the obtained iron oxide particles can be adjusted by whether the crushing and classification steps are performed or by selecting conditions of the crushing and classification steps.

Iron oxide particles according to the present invention or iron oxide particles obtained by a production method according to the present invention are preferably unlikely to aggregate or preferably do not aggregate from the viewpoint that inherent properties are likely to be exhibited, the handleability thereof is more excellent, and the dispersibility is more excellent when the iron oxide particles are used in such a manner that the iron oxide particles are dispersed in a dispersion medium. In the method for producing the iron oxide particles, the iron oxide particles are preferably obtained without performing the above-mentioned crushing step or classification step so as to be unlikely to aggregate or so as not to aggregate, because the crushing step or the classification step need not be performed and the iron oxide particles can be produced with high productivity so as to have excellent target properties.

### EXAMPLES

The present invention is further described below in detail with reference to examples. The present invention is not limited to the examples.

### Comparative Example 1

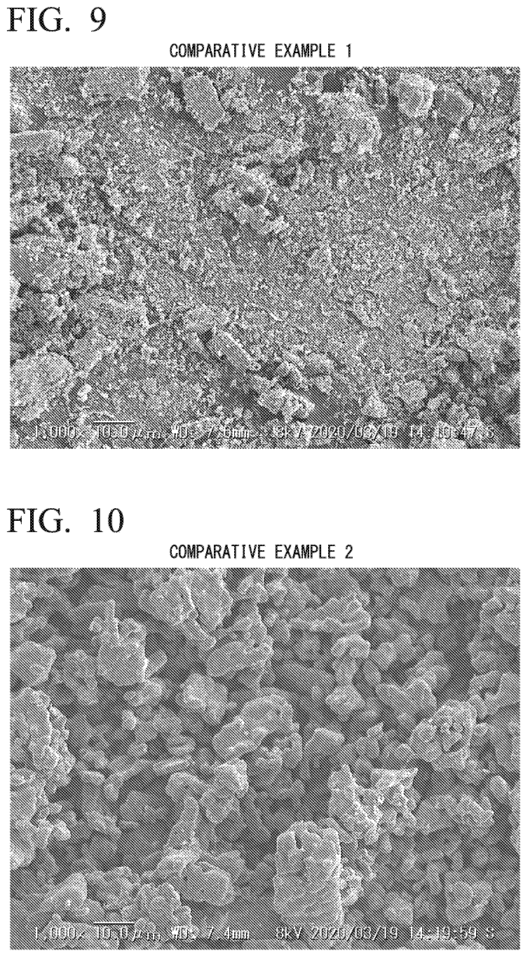

Iron oxide particles were obtained from red iron oxide (a reagent available from Kanto Chemical Co., Inc., α-Fe₂O₃, hematite) in Comparative Example 1. A SEM photograph of the iron oxide particles obtained in Comparative Example 1 was as shown in FIG. 9. The shape of the iron oxide particles was irregular.

### Comparative Example 2

(Production of Iron Oxide Particles)

Red iron oxide (a reagent available from Kanto Chemical Co., Inc., α-Fe₂O₃, hematite) was taken in an amount of 10.0 g, was put into a container, and was heat-treated in a sagger made of aluminum oxide under conditions below.

[Heat Treatment]

The sagger was heated from room temperature to 1,100° C. at 300° C./h, was held at 1,100° C. for ten hours, and was then cooled at 200° C./h using a furnace, SC-2045D-SP, available from Motoyama Co., Ltd.

Iron oxide particles obtained in Comparative Example 2 were black or brown. A SEM photograph of the iron oxide particles obtained in Comparative Example 2 was as shown in FIG. 10. It could be confirmed that the iron oxide particles obtained in Comparative Example 2 had a larger size due to particle growth as compared to the iron oxide particles obtained in Comparative Example 1 and were sintered. The iron oxide particles obtained in Comparative Example 2 had poor dispersibility, were aggregated, and had an irregular shape.

### Example 1

(Production of Iron Oxide Particles)

In a mortar, 9.5 g of iron oxide (a reagent available from Kanto Chemical Co., Inc.) and 0.5 g of molybdenum trioxide (MoO₃, available from Taiyo Koko Co., Ltd.) were mixed together, whereby a mixture was obtained. The obtained mixture was put into a crucible and was calcined at 1,100° C. for ten hours in a ceramic electric furnace. After cooling, an obtained solid was taken out of the crucible, whereby 9.6 g of a black powder was obtained.

Subsequently, after 9.0 g of the obtained black powder was dispersed in 100 mL of 0.5% ammonia water and the dispersion was stirred at room temperature (25° C. to 30° C.) for three hours, the ammonia water was removed by filtration and molybdenum remaining on the surfaces of particles was removed by water washing and drying, whereby 8.7 g of a black powder containing iron oxide particles was obtained.

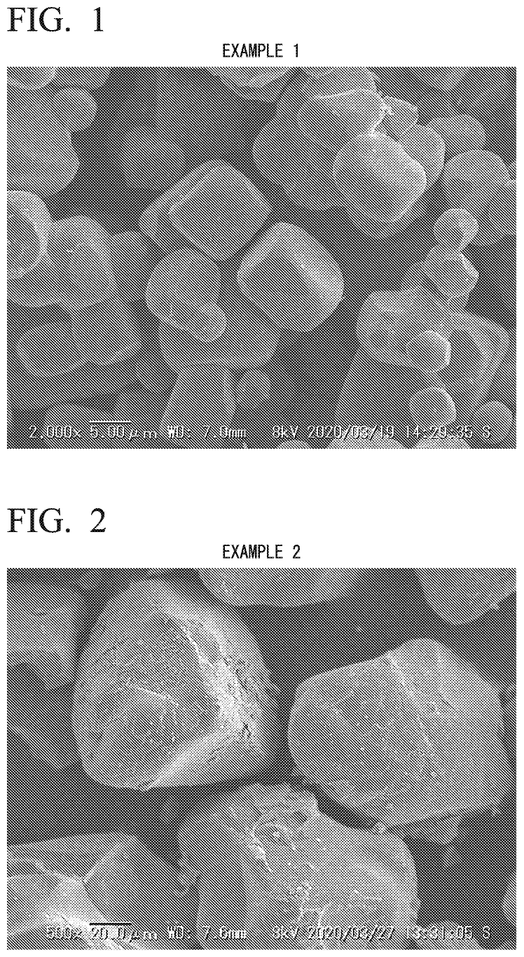

A SEM photograph of the iron oxide particles obtained in Example 1 was as shown in FIG. 1. The iron oxide particles were observed to have a polyhedral shape close to a cubic. The iron oxide particles obtained in Example 1 exhibited no conspicuous aggregation and had better dispersibility as compared to the iron oxide particles obtained in Comparative Examples 1 and 2.

### Example 2

(Production of Iron Oxide Particles)

A black powder containing iron oxide particles was obtained in substantially the same manner as that used in Example 1 except that the amounts of reagents used as raw materials in Example 1 were varied such that the amount of iron oxide (a reagent available from Kanto Chemical Co., Inc.) was 8.0 g and the amount of molybdenum trioxide (MoO₃, available from Taiyo Koko Co., Ltd.) was 2.0 g. A SEM photograph of the iron oxide particles obtained in Example 2 was as shown in FIG. 2. The iron oxide particles were observed to have a polyhedral shape. The iron oxide particles obtained in Example 2 exhibited no conspicuous aggregation and had better dispersibility as compared to the iron oxide particles obtained in Comparative Examples 1 and 2.

### Example 3

(Production of Iron Oxide Particles)

In a mortar, 10.0 g of iron oxide (a reagent available from Kanto Chemical Co., Inc.) and 10 g of lithium molybdate (Li₂MoO₄, a reagent available from Kanto Chemical Co., Inc.) were mixed together, whereby a mixture was obtained. The obtained mixture was put into a crucible and was calcined at 1,100° C. for ten hours in a ceramic electric furnace. After cooling, an obtained solid was taken out of the crucible, whereby 20 g of a black solid was obtained.

Subsequently, the obtained black solid was washed with water, water was removed by filtration, and lithium molybdate was removed by water washing and drying, whereby 8.5 g of a black powder containing iron oxide particles was obtained.

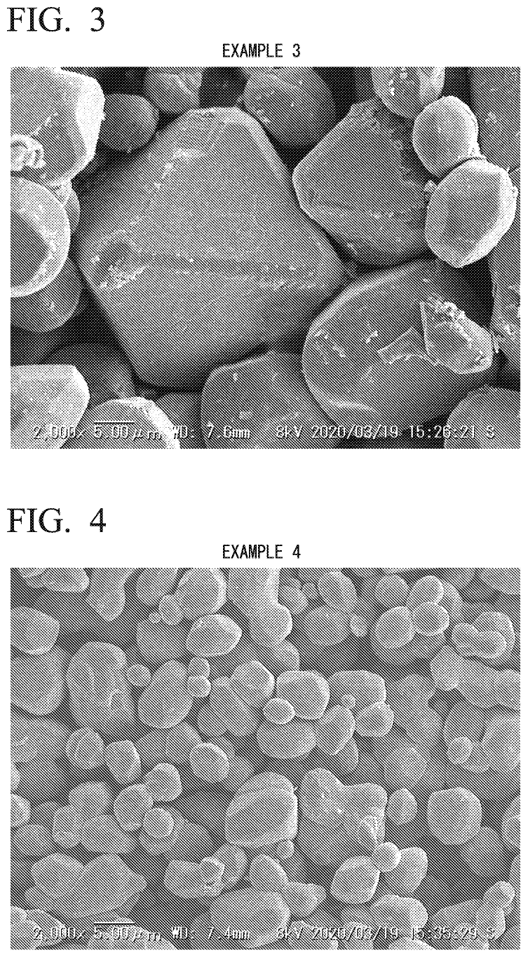

A SEM photograph of the iron oxide particles obtained in Example 3 was as shown in FIG. 3. The iron oxide particles were observed to have a polyhedral shape close to a regular octahedron. The iron oxide particles obtained in Example 3 exhibited no conspicuous aggregation and had better dispersibility as compared to the iron oxide particles obtained in Comparative Examples 1 and 2.

### Example 4

(Production of Iron Oxide Particles)

A black powder containing iron oxide particles was obtained in substantially the same manner as that used in Example 3 except that 10 g of lithium molybdate (a reagent available from Kanto Chemical Co., Inc.) used in Example 3 was changed to 10 g of potassium molybdate (K₂MoO₄ available from Kanto Chemical Co., Inc.). A SEM photograph of the iron oxide particles obtained in Example 4 was as shown in FIG. 4. The iron oxide particles were observed to have a polyhedral shape. The iron oxide particles obtained in Example 4 exhibited no conspicuous aggregation and had better dispersibility as compared to the iron oxide particles obtained in Comparative Examples 1 and 2.

### Example 5

(Production of Iron Oxide Particles)

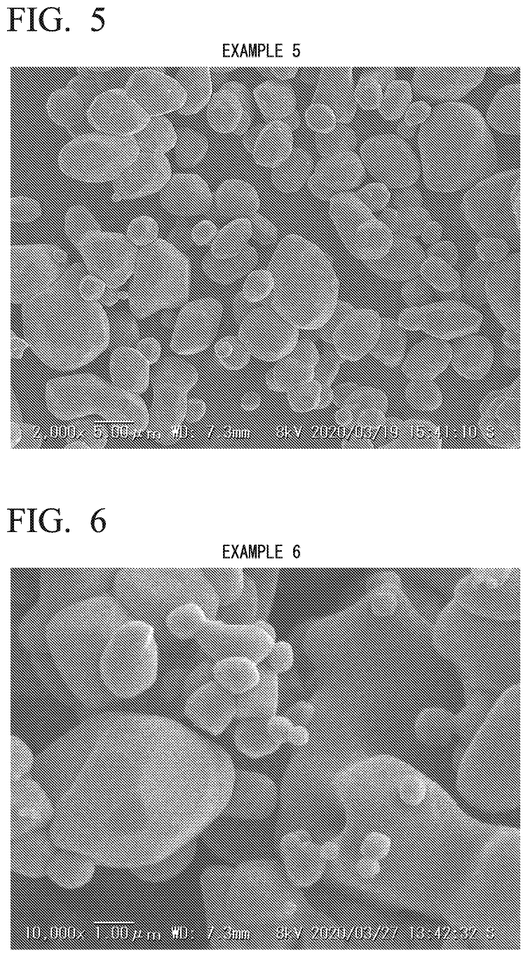

A black powder containing iron oxide particles was obtained in substantially the same manner as that used in Example 3 except that 10 g of lithium molybdate (a reagent available from Kanto Chemical Co., Inc.) used in Example 3 was changed to 12 g of sodium molybdate dihydrate (Na₂MoO₄·2H₂O, a reagent available from Kanto Chemical Co., Inc.). A SEM photograph of the iron oxide particles obtained in Example 5 was as shown in FIG. 5. The iron oxide particles were observed to have a polyhedral shape. The iron oxide particles obtained in Example 5 exhibited no conspicuous aggregation and had better dispersibility as compared to the iron oxide particles obtained in Comparative Examples 1 and 2.

### Example 6

(Production of Iron Oxide Particles)

A black powder containing iron oxide particles was obtained in substantially the same manner as that used in Example 2 except that the calcination temperature in Example 2 was changed to 900° C. A SEM photograph of the iron oxide particles obtained in Example 6 was as shown in FIG. 6. The iron oxide particles were observed to have a polyhedral shape. The iron oxide particles obtained in Example 6 exhibited no conspicuous aggregation and had better dispersibility as compared to the iron oxide particles obtained in Comparative Examples 1 and 2.

### Example 7

(Production of Iron Oxide Particles)

In a mortar, 10 g of iron oxide (a reagent available from Kanto Chemical Co., Inc.), 5.8 g of molybdenum trioxide (MoO₃, a reagent available from Taiyo Koko Co., Ltd.), and 6 g of potassium carbonate (K₂CO₃, a reagent available from Kanto Chemical Co., Inc.) were mixed together, whereby a mixture was obtained. The obtained mixture was put into a crucible and was calcined at 1,300° C. for ten hours in a ceramic electric furnace. After cooling, an obtained solid was taken out of the crucible, whereby 22 g of a black solid was obtained.

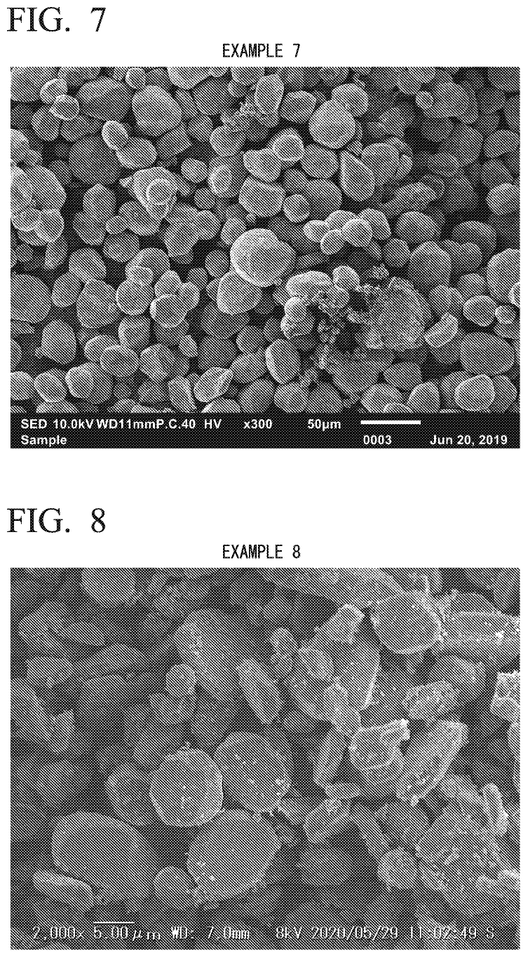

Subsequently, the obtained black solid was washed with water, water was removed by filtration, and potassium molybdate was removed by water washing and drying, whereby 9.0 g of a black powder containing iron oxide particles was obtained. A SEM photograph of the iron oxide particles obtained in Example 7 was as shown in FIG. 7. The iron oxide particles were observed to have a polyhedral shape. The iron oxide particles obtained in Example 7 exhibited no conspicuous aggregation and had better dispersibility as compared to the iron oxide particles obtained in Comparative Examples 1 and 2.

### Example 8

(Production of Iron Oxide Particles)

In a mortar, 10 g of iron oxide (a reagent available from Kanto Chemical Co., Inc.), 5.8 g of molybdenum trioxide (MoO₃, a reagent available from Taiyo Koko Co., Ltd.), 6 g of sodium carbonate (Na₂CO₃, a reagent available from Kanto Chemical Co., Inc.), and 0.5 g of silicon dioxide (a reagent available from Kanto Chemical Co., Inc.) were mixed together, whereby a mixture was obtained. The obtained mixture was put into a crucible and was calcined at 1,100° C. for ten hours in a ceramic electric furnace. After cooling, an obtained solid was taken out of the crucible, whereby 22 g of a black solid was obtained.

Subsequently, the obtained black solid was washed with water, water was removed by filtration, and sodium molybdate was removed by water washing and drying, whereby 9.0 g of a black powder containing iron oxide particles was obtained. A SEM photograph of the iron oxide particles obtained in Example 8 was as shown in FIG. 8. The iron oxide particles were observed to have a polyhedral shape close to a plate shape. The iron oxide particles obtained in Example 8 exhibited no conspicuous aggregation and had better dispersibility as compared to the iron oxide particles obtained in Comparative Examples 1 and 2.

TABLE 1

| | Fe₂O₃ | | MoO₃ | | K₂CO₃ | | Na₂CO₃ | | SiO₂ | | Li₂MoO₄ | | K₂MoO₄ | | Na₂MoO₄•2H₂O | | Maximum |
|---|---|---|---|---|---|---|---|---|---|---|---|---|---|---|---|---|---|
| | | Mass | | Mass | | Mass | | Mass | | Mass | | Mass | | Mass | | Mass | calcination |
| | | per- | | per- | | per- | | per- | | per- | | per- | | per- | | per- | temperature |
| | g | cent | g | cent | g | cent | g | cent | g | cent | g | cent | g | cent | g | cent | ° C. |
| Compar- | — | 100.0 | | | | | | | | | | | | | | | — |
| ative | | | | | | | | | | | | | | | | | |
| Example 1 | | | | | | | | | | | | | | | | | |
| Compar- | 10.0 | 100.0 | | | | | | | | | | | | | | | 1100 |
| ative | | | | | | | | | | | | | | | | | |
| Example 2 | | | | | | | | | | | | | | | | | |
| Example 1 | 9.5 | 95.0 | 0.5 | 5.0 | | | | | | | | | | | | | |
| Example 2 | 8.0 | 80.0 | 2.0 | 20.0 | | | | | | | | | | | | | |
| Example 3 | 10.0 | 50.0 | | | | | | | | | 10.0 | 50.0 | | | | | |
| Example 4 | 10.0 | 50.0 | | | | | | | | | | | 10.0 | 50.0 | | | |
| Example 5 | 10.0 | 45.5 | | | | | | | | | | | | | 12.0 | 54.5 | |
| Example 6 | 8.0 | 80.0 | 2.0 | 20.0 | | | | | | | | | | | | | 900 |
| Example 7 | 10.0 | 45.9 | 5.8 | 26.6 | 6.0 | 27.5 | | | | | | | | | | | 1100 |
| Example 8 | 10.0 | 44.8 | 5.8 | 26.0 | | | 6.0 | 26.9 | 0.5 | 2.2 | | | | | | | 1300 |

[Measurement of Average Size of Primary Particles of Iron Oxide Particles]

The iron oxide particles obtained in each of Comparative Examples 1 and 2 and Examples 1 to 8 were photographed with a scanning electron microscope (SEM). The smallest unit particles forming aggregates on a two-dimensional image (that is, primary particles) were measured for the maximum diameter (the Feret diameter of the longest portion observed) and the minimum diameter (the short Feret diameter perpendicular to the Feret diameter of the longest portion), and the average thereof was defined as the primary particle size. The same operation was performed for randomly selected 50 of the primary particles and the average size of the primary particles was calculated by averaging the sizes of the primary particles. Results were as shown in Table 2.

[Measurement of Crystallite Size]

Measurement was performed by powder X-ray diffraction (a 2θ/θ method) under conditions below using an X-ray diffractometer (SmartLab, available from Rigaku Corporation) equipped with a high-intensity, high-resolution crystal analyzer (CALSA) serving as a detector. Analysis was performed using the CALSA function of analysis software (PDXL) developed by Rigaku Corporation. The crystallite size of the [104] plane was calculated from the full width at half maximum of a peak appearing at a 2θ angle of about 33.2° using the Scherrer equation. The crystallite size of the [110] plane was calculated from the full width at half maximum of a peak appearing at a 2θ angle of about 35.6° using the Scherrer equation. Results were as shown in Table 2.

(Measurement conditions for Powder X-Ray Diffraction Method)
Tube voltage: 45 kV
Tube current: 200 mA
Scanning speed: 0.05 degrees/min
Scanning range: 10° to 70°
Step: 0.002°
βs: 20 rpm

System standard width: 0.026° as calculated using a standard silicon powder (NIST, 640d) prepared by the U.S. National Institute of Standards and Technology.

[Crystal Structure Analysis: X-Ray Diffraction (XRD) Method]

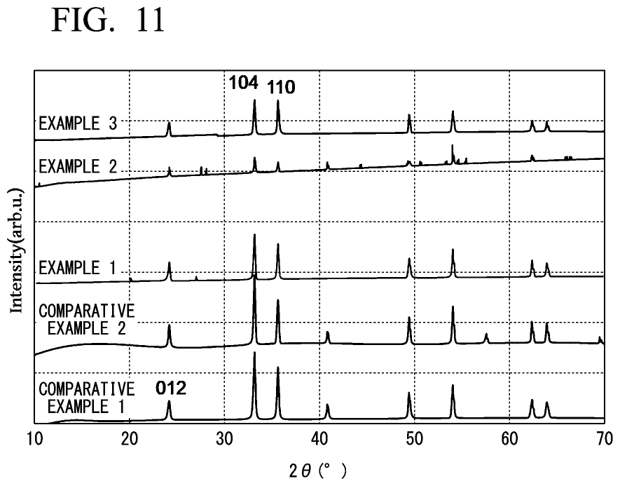

A sample of the iron oxide particles obtained in each of Examples 1 to 3 and Comparative Examples 1 and 2 was filled in a 0.5 mm deep holder for measurement samples, the holder was set to a wide-angle X-ray diffraction (XRD) instrument (Ultima IV, available from Rigaku Corporation), and the sample was measured under conditions including Cu Kα radiation, 40 kV/40 mA, a scanning speed of 2 degrees/min, and a scanning range of 10° to 70°. XRD measurement results of the iron oxide particles obtained in each of Examples 1 to 3 and Comparative Examples 1 and 2 were as shown in FIG. 11.

The diffraction peak of the [110] plane of hematite (α-Fe₂O₃) was observed at a 2θ angle of about 35.6°. The diffraction peak of the [104] plane of hematite (α-Fe₂O₃) was observed at a 2θ angle of about 33.2°. The diffraction peak of the [012] plane of hematite (α-Fe₂O₃) was observed at a 2θ angle of about 24.1°.

[Measurement of Size Distribution of Iron Oxide Particles]

The particle size distribution was measured in a dry mode under conditions including a dispersive pressure of 3 bar and a suction pressure of 90 mbar using a laser diffraction particle size distribution analyzer, HELOS (H3355) & RODOS R3:0.5/0.9-175 μm, available from Japan Laser Corporation, followed by determining the 10% diameter D₁₀, the median diameter D₅₀, and the 90% diameter D₉₀. Furthermore, the value of (D₉₀−D₁₀)/D₅₀ was calculated. Results were as shown in Table 2.

[Measurement of Isoelectric Point of Iron Oxide Particles]

The iron oxide particles obtained in each of Comparative Examples 1 and 2 and Examples 1 to 8 were measured for zeta potential using a zeta potential analyzer, Zetasizer Nano ZSP, available from Malvern Instruments. A supernatant liquid was obtained in such a manner that 20 mg of a sample of the iron oxide particles and 10 mL of a 10 mM aqueous solution of KCl were mixed for three minutes in Awatori Rentaro (ARE-310, Thinky Corporation) in a stirring/defoaming mode and the mixture was left stationary for five minutes. The supernatant liquid was used as a measurement sample. The measurement sample was measured for zeta potential in a range down to a pH of 2 (an application voltage of 100 V, a monomodal mode) in such a manner that 0.1 N HCl was added to the measurement sample using an automatic titrator, whereby the pH of the isoelectric point at which the potential was 0 (zero). Results were as shown in Table 2.

[Measurement of Specific Surface Area of Iron Oxide Particles]

The iron oxide particles obtained in each of Comparative Examples 1 and 2 and Examples 1 to 8 were measured for specific surface area using a specific surface area analyzer (BELSORP-mini, available from MicrotracBEL Corporation). The surface area per gram of a measured sample was calculated from the amount of adsorbed nitrogen by the BET method as a specific surface area (m²/g). Results were as shown in Table 2.

[Measurement of Purity of Iron Oxide Particles: X-Ray Fluorescence (XRF) Analysis]

About 70 mg of a sample of the iron oxide particles obtained in each of Comparative Examples 1 and 2 and Examples 1 to 8 was taken on a sheet of filter paper, was covered with a PP film, and was analyzed for composition under conditions below using an X-ray fluorescence analyzer, Primus IV, available from Rigaku Corporation.

Measurement conditions
EZ scan mode
Measurement elements: F to U
Measurement time: standard
Measurement diameter: 10 mm
Residue (balance component): not present

The Fe₂O₃ content (F₁) and MoO₃ (M₁) content of the iron oxide particles were determined by XRF analysis in terms of Fe₂O₃ (mass percent) and MoO₃ (mass percent) with respect to 100% by mass of the iron oxide particles. Results were as shown in Table 2.

[XPS Surface Analysis]

A sample prepared from the iron oxide particles obtained in each of Comparative Examples 1 and 2 and Examples 1 to 8 was press-fixed onto a double-sided tape and was analyzed for composition under conditions below using an X-ray photoelectron spectroscopy (XPS) instrument, Quantera SNM, available from Ulvac-Phi Inc.
X-ray source: monochromatized Al Kα, a beam diameter of 100 μmφ, a power of 25 W
Measurement: area measurement (1,000 μm square), n=3
Charge correction: C1s=284.8 eV

The Fe₂O₃ content (F₂) and MoO₃ (M₂) content of a surface layer of each iron oxide particle were determined from XPS analysis results in terms of Fe₂O₃ (mass percent) and MoO₃ (mass percent) with respect to 100% by mass of the iron oxide particle. Results were as shown in Table 2. The ratio of the MoO₃ (M₂) content of the surface layer of the iron oxide particle as determined by the XPS surface analysis of the iron oxide particle to the MoO₃ (M₁) content of the iron oxide particle as determined by the XRF analysis of the iron oxide particle, that is, the surface uneven distribution ratio (M₂/M₁) was calculated. Results were as shown in Table 2.

TABLE 2

| | | | | Crystallite | | | | | | |
|---|---|---|---|---|---|---|---|---|---|---|
| | | | Average | size | | | | | | |
| | | | particle | [110] | [104] | Particle size distribution | | | | Isoelectric |
| | | | size | plane | plane | | | | (D₉₀ − D₁₀)/ | point |
| | | | (SEM) | 35.6° | 33.2° | D₁₀ | D₅₀ | D₉₀ | D₅₀ | pH |
| | Color | Shape | μm | nm | nm | μm | μm | μm | — | — |
| Comparative | Red | Irregular | <1 | 157 | 171 | — | — | — | — | 4.1 |
| Example 1 | | | | | | | | | | |
| Comparative | Black | Irregular | 20.0 | 311 | 388 | 0.7 | 6.0 | 14.0 | 2.2 | — |
| Example 2 | | | | | | | | | | |
| Example 1 | Black | Cubic | 15.0 | 512 | 476 | 7.6 | 15.2 | 30.4 | 1.5 | 3.3 |
| Example 2 | Black | Polyhedral | 100.0 | 350 | 265 | 45.0 | 96.5 | 146.0 | 1.0 | 3.2 |
| Example 3 | Black | Octahedral | 20.0 | 299 | 455 | 12.0 | 20.3 | 33.7 | 1.1 | 2.9 |
| Example 4 | Black | Polyhedral | 10.0 | 360 | 311 | 4.6 | 8.9 | 18.6 | 1.6 | 3.1 |
| Example 5 | Black | Polyhedral | 12.0 | 347 | 369 | 4.7 | 9.4 | 21.7 | 1.8 | 2.8 |
| Example 6 | Black | Polyhedral | 8.0 | 350 | 281 | 2.3 | 7.2 | 15.0 | 1.8 | 3.5 |
| Example 7 | Black | Polyhedral | 80.0 | — | — | 45.7 | 72.4 | 112.6 | 0.9 | 3.7 |
| Example 8 | Black | Plate | 5.0 | 370 | 320 | 2.0 | 1.3 | 10.5 | 1.9 | 4.0 |

| | | | | XPS | | |
|---|---|---|---|---|---|---|
| | | | | surface | | Ratio of |
| | Specific | XRF analysis | | analysis | | surface |
| | surface | Fe₂O₃ | MoO₃ | Fe₂O₃ | MoO₃ | enrichment |
| | area | (F₁) | (M₁) | (F₂) | (M₂) | MoO₃ |
| | (BET) | Mass | Mass | Mass | Mass | (M₂/M₁) |
| | m²/g | percent | percent | percent | percent | — |
| Comparative | 3.20 | 99.9 | 0.0 | 100.0 | 0.0 | — |
| Example 1 | | | | | | |
| Comparative | 0.15 | 100.0 | 0.0 | 100.0 | 0.0 | — |
| Example 2 | | | | | | |
| Example 1 | 0.20 | 99.7 | 0.1 | 95.4 | 4.6 | 46.0 |
| Example 2 | 0.05 | 96.3 | 3.3 | 92.6 | 7.4 | 2.2 |
| Example 3 | 0.10 | 98.4 | 1.4 | 88.0 | 11.9 | 8.5 |
| Example 4 | 0.15 | 99.9 | 0.1 | 94.5 | 5.5 | 55.0 |
| Example 5 | 0.15 | 99.9 | 0.1 | 94.4 | 5.6 | 56.0 |
| Example 6 | 0.40 | 98.7 | 1.2 | 91.2 | 8.8 | 7.3 |
| Example 7 | 0.05 | 99.9 | 0.1 | 95.5 | 4.5 | 45.0 |
| Example 8 | 0.30 | 98.5 | 1.5 | 90.9 | 9.1 | 6.1 |

The iron oxide particles obtained in each of Examples 1 to 8 contained molybdenum, were shape-controlled particles, had a polyhedral shape different from that of conventional iron oxide particles, had a narrow size distribution, exhibited lower aggregation as compared to the conventional iron oxide particles, and had a relatively large crystallite size. In the iron oxide particles obtained in each of Examples 1 to 8, the MoO₃ content (M₂) determined by XPS surface analysis was higher than the MoO₃ content (M₁) determined by XRF analysis and therefore it could be confirmed that molybdenum was selectively rich in a surface layer of each iron oxide particle. The iron oxide particles obtained in each of Examples 1 to 8 had high electrostatic repulsion and were excellent in dispersion stability because molybdenum was u selectively rich in the surface layer and therefore the pH of the isoelectric point was shifted to the acidic side as compared to that of the conventional iron oxide particles.

### INDUSTRIAL APPLICABILITY

Iron oxide particles according to the present invention can be expected to be used as pigment for paints, cosmetics, and the like.

1. Iron oxide particles having a polyhedral shape, containing molybdenum.

2. The iron oxide particles according to claim 1, wherein the crystallite size of the plane of the iron oxide particles is 280 nm or more.

3. The iron oxide particles according to claim 1, wherein the crystallite size of the plane of the iron oxide particles is 260 nm or more.

4. The iron oxide particles according to claim 1, wherein the median diameter Dso of the iron oxide particles is 0.1 μm to 1,000 μm as determined by a laser diffraction/scattering method.

5. The iron oxide particles according to claim 1, wherein the dispersity index S of the iron oxide particles is 2.0 or less as calculated from the 10% diameter D10, median diameter Dso, and 90% diameter D90 determined by the laser diffraction/scattering method using the following equation:
S=(D90−D10)/Dso (1).

6. The iron oxide particles according to claim 1, wherein the Fe₂O₃ content (F1) of the iron oxide particles is 95.0% by mass to 99.99% by mass as determined by the XRF analysis of the iron oxide particles and the MoO3 content (Mi) of the iron oxide particles is 0.01% by mass to 5.0% by mass as determined by the XRF analysis of the iron oxide particles.

7. The iron oxide particles according to claim 1, wherein the molybdenum is selectively rich in a surface layer of each iron oxide particle.

8. The iron oxide particles according to claim 1, wherein the Fe2O3 content (F2) of a surface layer of each iron oxide particle is 88.0% by mass to 97.0% by mass as determined by the XPS surface analysis of the iron oxide particle and the MoO3 content (M2) of the surface layer of the iron oxide particle is 3.0% by mass to 12.0% by mass as determined by the XPS surface analysis of the iron oxide particle.

9. The iron oxide particles according to claim 1, wherein the pH of the isoelectric point at which the potential is 0 is 2 to 5 as determined by zeta potential measurement.

10. The iron oxide particles according to claim 1, wherein the specific surface area is 50 m2/g or less as determined by the BET method.

11. A method for producing the iron oxide particles according to claim 1, the method comprising calcining an iron compound in the presence of a molybdenum compound.

12. The method according to claim 11, wherein the iron compound is calcined in the presence of the molybdenum compound and an alkali metal compound.

13. The method according to claim 12, wherein the alkali metal compound is an alkali metal oxide, an alkali metal hydroxide, an alkali metal carbonate, or an alkali metal chloride.

14. The method according to claim 11, wherein the molybdenum compound is molybdenum trioxide, lithium molybdate, potassium molybdate, or sodium molybdate.

15. The method according to claim 11, wherein the maximum calcination temperature at which the iron compound is calcined is 800° C. to 1,600° C.
